(19) United States
(12) Patent Application Publication
(10) Pub. No.: US 2015/0067024 A1
(43) Pub. Date: Mar. 5, 2015

(54) AUTOBATCHING

(71) Applicant: Apple Inc., Cupertino, CA (US)

(72) Inventor: Andrew John Nesbitt, Cupertino, CA (US)

(73) Assignee: Apple Inc., Cupertino, CA (US)

(21) Appl. No.: 14/011,514

(22) Filed: Aug. 27, 2013

(51) Int. Cl. H04L 29/08

(52) U.S. Cl. CPC H04L 67/02
USPC 709/203

(57) ABSTRACT

An autobatching module collects multiple requests from a webpage based on an organizational schema, batches the multiple requests received in each particular time frame, and transmits a batch requests to the server. The autobatching module receives responses to the batched requests from the server, parses the responses, and delivers the responses to the webpage and to appropriate objects and widgets.

### BACKGROUND

1. Technical Field

The present disclosure relates to batching requests made to a server. More specifically, the present disclosure relates to automatically batching requests made to a server using an organizational schema.

2. Introduction

Web pages are designed in programming code, such as hypertext markup language (“HTML”), that can be read by a web browser on a client device. The web browser reads the code and makes requests to a server for resources described in the code that will be published on the web page in the browser. Commonly, requests are made to the server using a transfer protocol, such as hypertext transfer protocol (“HTTP”). The client submits an HTTP request message to the server, the server provides resources or performs other functions on behalf of the client, and the server returns a response message to the client. Webpages can also be designed with widgets, which are auxiliary applications that occupy a portion of a webpage and perform a function using information fetched from other websites. Like other aspects of the webpage, widgets make requests to a server for content.

Common webpages can include a large amount of programming code and can include multiple widgets, each making multiple requests to the server. Additionally, many web browsers limit the amount of concurrent requests that can be made to a server. Therefore, when more than an allotted amount of widgets are concurrently trying to get information from the server, the webpage will appear to load very slowly. Similarly, when a webpage involves multiple widgets, the timing of the requests is non-deterministic. In operation, this means that the widgets receive responses from the server in a similarly non-deterministic sequence and the widgets can load in seemingly chaotic or arbitrary sequence.

Web page developers can attempt to organize their programming code and their use of widgets to account for timing of their respective requests; however, this takes a great deal of manual organization and time. Also, making changes to the web code while maintaining the organization is extremely difficult.

### SUMMARY

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Disclosed are systems, methods, devices, and non-transitory computer-readable storage media for automatically batching server requests from an application, a widget module, or a client web browser.

Some embodiments of the present technology involve a autobatching module defined in web code that collects, over various time frames, multiple requests from a webpage, batches the multiple requests received in each particular time frame, and transmits a batch of requests to the server. The autobatching module receives responses to the batched requests from the server, parses the responses, and delivers the responses to the webpage and thereby to appropriate objects and widgets.

Some embodiments of the present technology involve a widget module for gathering requests from a web browser and from widgets on a web page and for sending the requests to a server. The widget module can be operatively coupled with a batching module configured to collect requests from the widget module, batch the requests using an organizational scheme, and transmit the batched request to the server. The batching module can be further configured to receive a reply to the batched request from the server, parse the reply into individual responses, and send the individual responses to the widget module.

In some embodiments, the batching module can use a time-based organizational scheme and can collect requests received from the widget module during a first time period into a first batch, collect requests received from the widget module during a second time period into a second batch, and transmit the first batch and the second batch of requests to the server in separate communications.

In some embodiments, the batching module can determine that a response to a request contained in a batch and transmitted to the server is not received from the server before a predetermined threshold period closes and can send the server an interrupt signal configured to request that the server deliver a partial reply batch request despite the non-received request. The batching module can also determine that a particular request is configured to circumvent the batching process.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an exemplary system for automatically batching server requests according to some embodiments of the present technology;

FIG. 2 illustrates an exemplary system for automatically batching server requests by an autobatching module received from a client-side widget module according to some embodiments of the present technology;

FIG. 3 illustrates an exemplary method for automatically batching requests made by widgets on a web page according to some embodiments of the present technology;

FIG. 4 illustrates an exemplary method for automatically batching requests made by widgets on a web page and enforcing a timeout feature according to some embodiments of the present technology;

FIG. 5 illustrates an exemplary method of automatically batching requests made by widgets on a web page and enforcing a kick-queue feature according to some embodiments of the present technology; and

FIGS. 6A and 6B illustrate exemplary possible system embodiments.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

The present disclosure addresses the need in the art for systems, methods, devices, and non-transitory computer-readable storage media for automatically batching server requests from an application or client web browser.

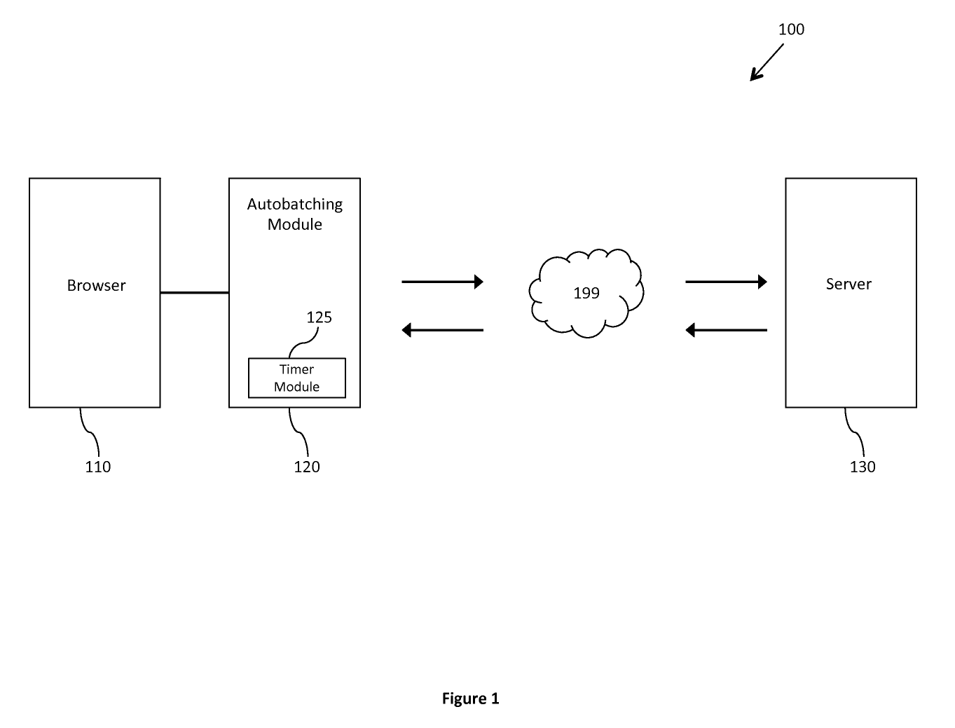

FIG. 1 illustrates a system 100 for automatically batching server requests according to some embodiments of the present technology. The system 100 includes a web browser 110 that can read programming code and make requests to a server 130 for resources described in the code. The browser 110 and server 130 communicate over a network 199. Those with ordinary skill in the art having the benefit of this disclosure will readily appreciate that the network 199 can be one network or multiple networks.

According to the present technology, the browser 110 can utilize a autobatching module 120 that is configured to automatically batch requests made by the browser, send the batched request to the server, receive a response containing all the resources described in the individual requests that included in the batch, unpack the content requested by the individual requests, and deliver the requested resources to the appropriate widgets.

The autobatching module 120 applies an organizational schema used to logically batch requests. For example, in some embodiments, the autobatching module 120 includes a timer module 125 that is used to automatically batch the individual requests based on the time that the requests are made after the browser 110 begins loading a web page. A first batch of requests are gathered during a first time period and sent to the server 130. While the autobatching module 120 awaits a response to the first batch of requests, the autobatching module 120 gathers additional batches during additional time periods and queues these subsequent batches. Once a response is returned, the autobatching module 120 sent the next batch of requests to the server 130. Although automatically organizing batches of requests based on their timing is mentioned explicitly, those with ordinary skill in the art having the benefit of this disclosure will readily appreciated that a wide variety of organization schemes can be used to organize request batches.

In some embodiments of the present technology, the server 130 is especially configured for receiving requests in batched form, executing those requests, and sending responses in a batched format.

In some embodiments, the autobatching module 120 is a part of a web browser application itself. Additionally, in some embodiments, the autobatching module 120 can be a hardware device coupled to a processing device that runs the web browser on the client-side, that organizes traffic coming into a server on the server-side, or that performs both client-side and server-side functions. The autobatching module 120 can also be embodied as independent executable software on a computer readable storage medium on the client-side, the server-side, or both the client-side and the server-side.

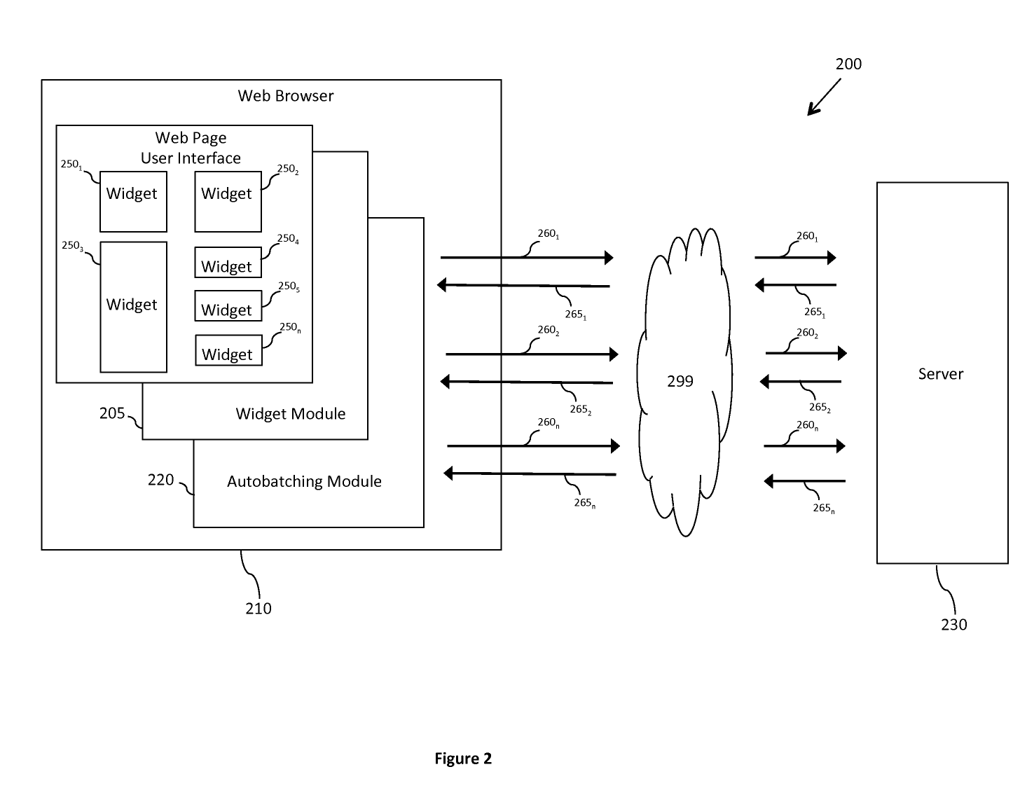

FIG. 2 illustrates a system 200 for automatically batching server requests from a client-side web browser 210 according to some embodiments of the present technology. The web browser 210 displays a web page user interface 202 containing a plurality of widgets 250₁, 250₂, 250₃, 250₄, 250₅, . . . , 250ₙ. The plurality of widgets 250₁, 250₂, 250₃, 250₄, 250₅, . . . , 250ₙ can be displayed by the web browser 210 upon programming code being executed by a widget module 205 and making requests to a server 230 using a autobatching module 220.

For example, the widget module 205 can be a page of Javascript code including a plurality of code blocks for making requests from individual widgets with each widget configured to display information about upcoming concerts. For example, a first widget can request information about concerts in San Francisco, a second widget can request information about concerts in Belfast, a third widget can request information about concerts by a particular artist, and so on.

As explained above, traditional methods of sending requests can occur in a non-deterministic fashion that can cause the web page to load in a similarly non-deterministic sequence. The autobatching module 220 of the present technology can sidestep this phenomenon by batching requests made by all the widgets 250₁, 250₂, 250₃, 250₄, 250₅, . . . , 250ₙ based on an organization scheme, e.g. timing of the requests. Indeed, using the autobatching module 220 can result in the widgets 250₁, 250₂, 250₃, 250₄, 250₅, . . . , 250ₙ loading in a more uniform fashion. Additionally, since each batch of requests is sent to the server as a package, the load on the web browser 210 is reduced. Likewise, a developer can design a web page or application without being required to organize the timing of the request events originating from widgets because the autobatching module 220 itself applies an organizational schema. Also, as explained below, some embodiments of the present technology involve the autobatching module 220 receiving responses for all of the requests at substantially the same time, thereby causing the webpage to load in a more consistent manner.

The autobatching module 220 identifies batches of requests based on the organizational schema and sends the batches of requests to the server 230 in batches 260₁, 260₂, . . . 260ₙ via a network 299. First, the autobatching module 220 transmits the first batch 260₁ of requests. The server 230 processes each of the requests in a first batch 260₁, obtains all of the responses for the requests described in the batch requests, and sends batched responses 265₁ back to the autobatching module 220 via the network 299.

Upon receiving the first batch 265₁ of responses, the autobatching module 220 can unpack the responses requested by the individual requests from the batch of responses and can deliver the requested resources to the appropriate widgets. Also upon receiving the first batch of responses 265₁, the autobatching module 220 can also transmit the second batch 260₂ of requests. The process can iterate until all of the batches are sent and all of the responses are received. In addition to this above-mentioned iterative process, some embodiments of the present technology can involve various other steps such as applying a kick-queue function and enforcing a smart timeout feature to avoid waiting unnecessarily long for a single response. Kick-queue functions and timeout features as used in the present technology are described in more detail below.

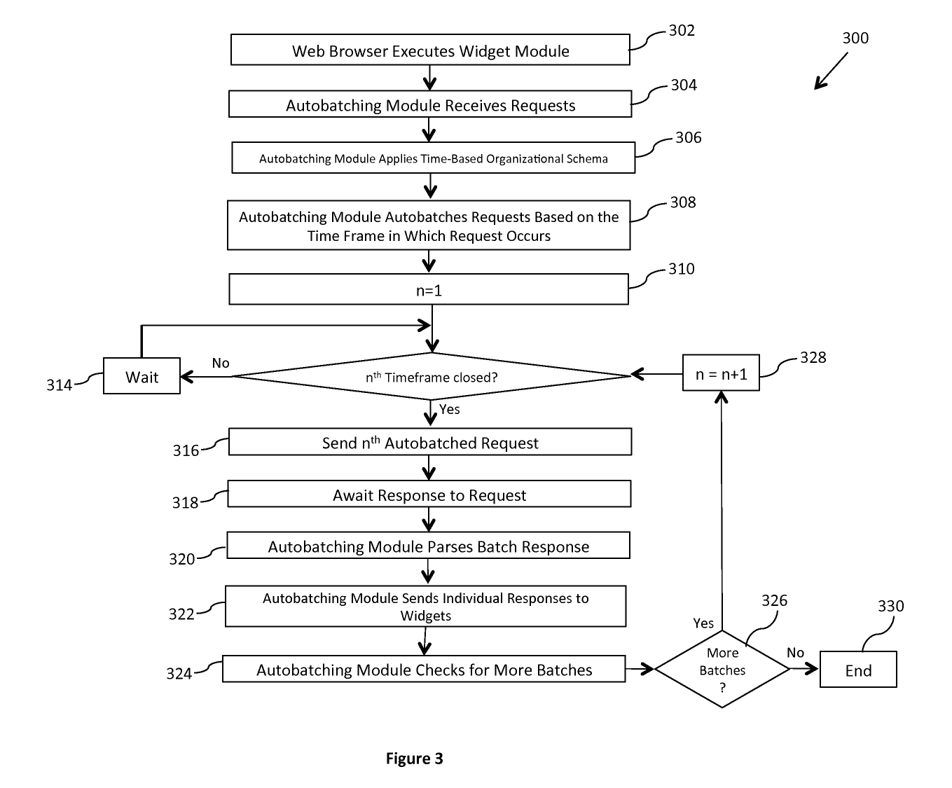

FIG. 3 illustrates a method 300 for automatically batching requests made by widgets on a web page according to some embodiments of the present technology. The method 300 involves a web browser executing a widget module 302 for collecting requests from a group of widgets on the web page. Next, the autobatching module receives the requests as they are made 304 and applies a time-based organizational schema 306. In a particular example, three time frames are used in a time-based organizational schema and are timed at one hundred milliseconds, two seconds, and five seconds.

The autobatching module then begins to automatically batch requests based on the organizational schema and based on the time frame in which the requests occur 308. First, a time frame is opened 310 and the autobatching module determines if a current timeframe has closed 312. If not, the autobatching module waits 314 and asks again 312. If the current timeframe has closed, the autobatching module sends the current batch of requests to the server 316 and awaits a batch response 318 from the server.

In some embodiments of the present technology, the server collects all of the responses to the batch of requests before sending the response. Indeed, this practice causes the autobatching module to receive responses for all of the requests in a batch at substantially the same time, thereby causing the webpage to load in a more consistent manner.

Once the responses are received, the autobatching module parses the batch responses to extract individual responses 320 and sends the individual responses to the widgets 322. In some embodiments of the present technology, some of the steps are performed in parallel. For example, a second request can be sent before the response is received for the first batch.

Next, the autobatching module checks for remaining batches 324 and determines 326 whether any more batches remain that have yet to have their requests sent. If so, the autobatching module increases the timeframe count 328 and the autobatching process iterates. If no remaining batches exist, the method 300 terminates 330.

In addition to automatically batching requests from widgets, some embodiments of the present technology involve a smart timeout feature to avoid the web page waiting for a response to a request contained in a given batch if the response is not received within a predetermined threshold.

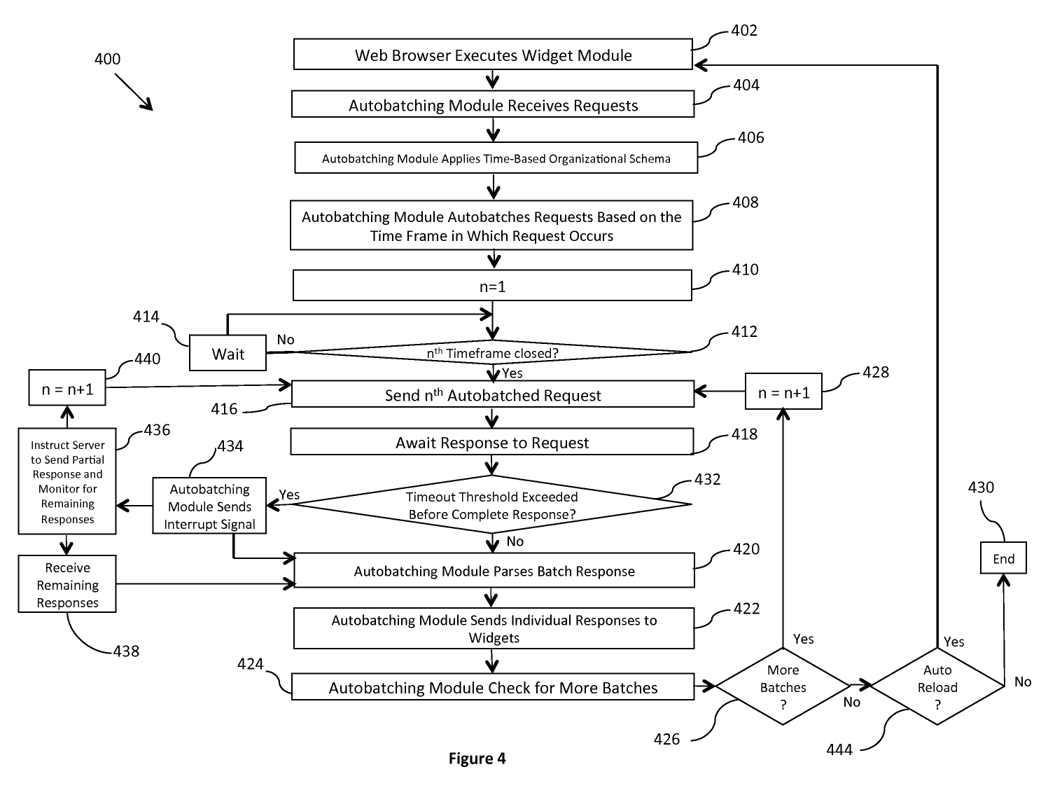

FIG. 4 illustrates a method 400 for automatically batching requests made by widgets on a web page and enforcing a timeout feature according to some embodiments of the present technology. The method 400 involves a web browser executing a widget module 402 for collecting requests from a group of widgets on the web page. Next, the autobatching module receives the requests as they are made 404 and applies a time-based organizational schema 406.

The autobatching module then begins to automatically batch requests based on the organizational schema and based on the time frame in which the requests occur 408. First, a time frame is opened 410 and the autobatching module determines if a current timeframe has closed 412. If not, the autobatching module waits 414 and asks again 412. If the current timeframe has closed, the autobatching module sends the current batch of requests to the server 416 and awaits a batch response 418 from the server.

The method 400 also enforces a timeout mechanism to avoid an entire web page having to wait for a response to a request contained within a batch of requests. Indeed, upon beginning to wait for a response to a batch of requests, the autobatching module starts a timer to determine whether a threshold time is exceeded before receiving the batch of responses to the batch of requests 432. If so, the autobatching module sends the server an interrupt signal 434 instructing the server to send the autobatching module a partial response and instructing the server to keep monitoring for missing responses while processing subsequent batch requests 436. The autobatching module then increases the timeframe count 440 and the autobatching process iterates. Upon the server obtaining the missing response, the autobatching module can receive the remaining responses 438.

If the timeout threshold is not reached and a full response is received by the autobatching module, or if the autobatching module receives a partial response, the autobatching module parses the batch response to extract individual responses 420 and sends the individual responses to the widgets 422.

Next, the autobatching module checks for remaining batches 424 and determines 426 whether any more batches remain that have yet to have their requests sent. If so, the timeframe count is increased 428 and the autobatching process iterates.

Some embodiments of the present technology also involve accounting for pages set to automatically reload. For example, as illustrated in FIG. 4, if no remaining batches exist, the method 400 determines if the webpage is configured to automatically reload 444. If so, the method 400 iterates to step 402; if not, the method 400 terminates 430.

When designing a web page that will be processed using an autobatching module, a developer can chose to design the webpage in a fashion that dictates that certain information should be loaded before other information. For example, when designing a WIKI page, a developer can specify that the headings in the WIKI should be requested and received irrespective of how an autobatching organizational schema might otherwise put the request for heading information into a subsequent batch. Indeed, some embodiments of the present technology involve an autobatching module that can enforce rules that allow some server requests to ignore the organizational scheme of the autobatching module (i.e. “kick-queue” requests.)

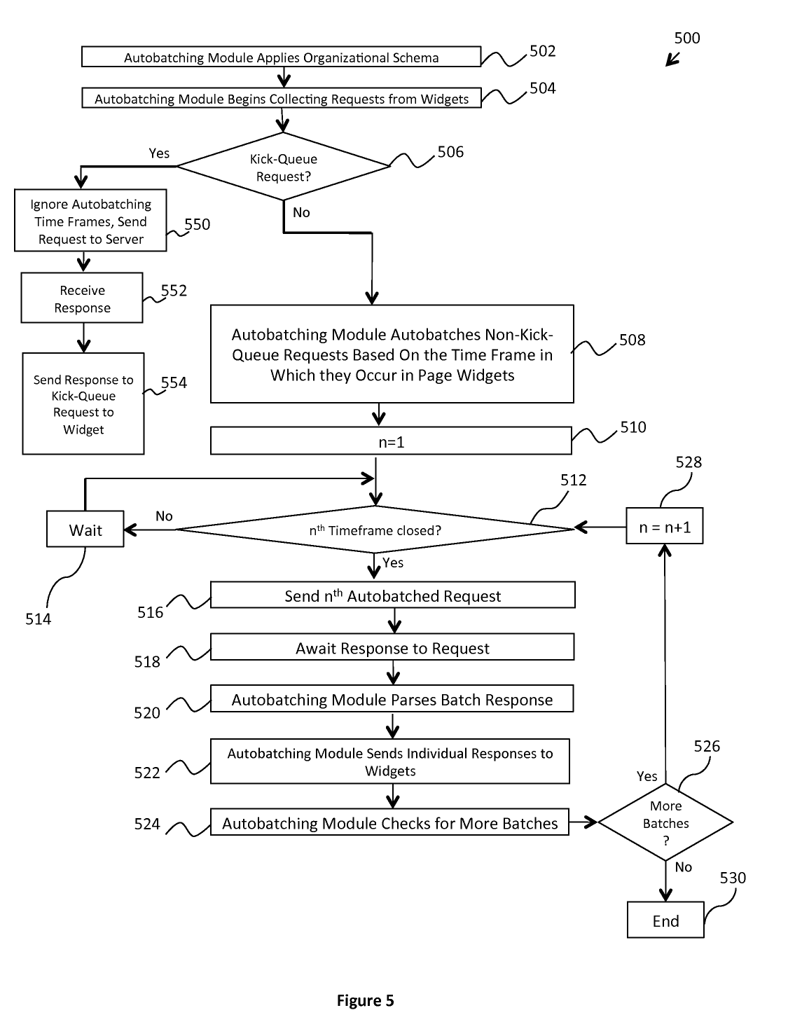

FIG. 5 illustrates a method 500 of automatically batching requests made by widgets on a web page and enforcing a kick-queue feature according to some embodiments of the present technology. The method 500 begins with the autobatching module applying a time-based organizational schema 502. Next, the autobatching module begins to collect requests from the widgets 504 and determines 506 whether the incoming requests are specified as a “kick-queue” request that is designated as being configured to ignore the organization scheme of the autobatching module. If an incoming request is a kick-queue request, the autobatching module ignores the defined time frames and immediately sends the request to the server 550. Subsequently, the autobatching module receives a response from the server 552, and sends the response to the kick-queue request to the requesting widget 554.

If the requests are not kick-queue requests, the autobatching module then begins to automatically batch non-kick-queue requests based on the time frame in which they occur 508. A time frame is opened 510 and the autobatching module determines if a current timeframe has closed 512. If not, the autobatching module waits 514 and asks again 512. If the current timeframe has closed, the autobatching module sends the current batch of requests to the server 516 and awaits a batch response 518 from the server. Once a response is received, the autobatching module parses the batch response to extract individual responses 520 and sends the individual responses to the widgets 522.

Next, the autobatching module checks for remaining batches 524 and determines 526 whether any more batches remain they have yet to have their requests sent. If so, the autobatching module increases the timeframe count 528 and the autobatching process iterates. If no remaining batches exist, the method 500 terminates 530.

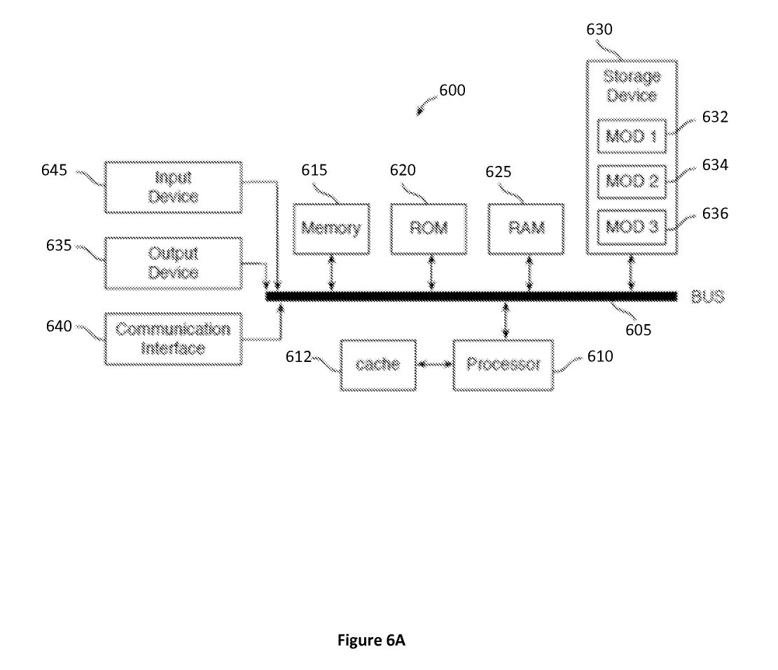

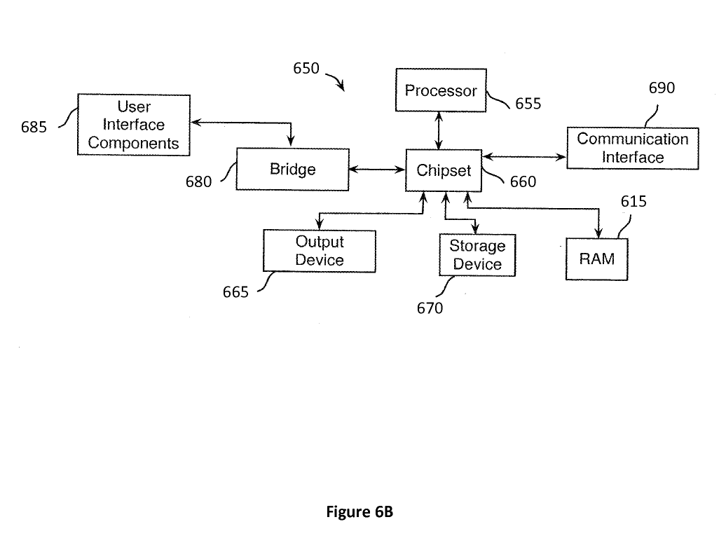

FIG. 6A and FIG. 6B illustrate exemplary possible system embodiments. The more appropriate embodiment will be apparent to those of ordinary skill in the art when practicing the present technology. Persons of ordinary skill in the art will also readily appreciate that other system embodiments are possible.

FIG. 6A illustrates a conventional system bus computing system architecture 600 wherein the components of the system are in electrical communication with each other using a bus 605. Exemplary system 600 includes a processing unit (CPU or processor) 610 and a system bus 605 that couples various system components including the system memory 615, such as read only memory (ROM) 620 and random access memory (RAM) 625, to the processor 610. The system 600 can include a cache of high-speed memory connected directly with, in close proximity to, or integrated as part of the processor 610. The system 600 can copy data from the memory 615 and/or the storage device 630 to the cache 612 for quick access by the processor 610. In this way, the cache can provide a performance boost that avoids processor 610 delays while waiting for data. These and other modules can control or be configured to control the processor 610 to perform various actions. Other system memory 615 may be available for use as well. The memory 615 can include multiple different types of memory with different performance characteristics. The processor 610 can include any general purpose processor and a hardware module or software module, such as module 1 632, module 2 634, and module 3 636 stored in storage device 630, configured to control the processor 610 as well as a special-purpose processor where software instructions are incorporated into the actual processor design. The processor 610 may essentially be a completely self-contained computing system, containing multiple cores or processors, a bus, memory controller, cache, etc. A multi-core processor may be symmetric or asymmetric.

To enable user interaction with the computing device 600, an input device 645 can represent any number of input mechanisms, such as a microphone for speech, a touch-sensitive screen for gesture or graphical input, keyboard, mouse, motion input, speech and so forth. An output device 635 can also be one or more of a number of output mechanisms known to those of skill in the art. In some instances, multimodal systems can enable a user to provide multiple types of input to communicate with the computing device 600. The communications interface 640 can generally govern and manage the user input and system output. There is no restriction on operating on any particular hardware arrangement and therefore the basic features here may easily be substituted for improved hardware or firmware arrangements as they are developed.

Storage device 630 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 625, read only memory (ROM) 620, and hybrids thereof.

The storage device 630 can include software modules 632, 634, 636 for controlling the processor 610. Other hardware or software modules are contemplated. The storage device 630 can be connected to the system bus 605. In one aspect, a hardware module that performs a particular function can include the software component stored in a computer-readable medium in connection with the necessary hardware components, such as the processor 610, bus 605, display 635, and so forth, to carry out the function.

FIG. 6B illustrates a computer system 650 having a chipset architecture that can be used in executing the described method and generating and displaying a graphical user interface (GUI). Computer system 650 is an example of computer hardware, software, and firmware that can be used to implement the disclosed technology. System 650 can include a processor 655, representative of any number of physically and/or logically distinct resources capable of executing software, firmware, and hardware configured to perform identified computations. Processor 655 can communicate with a chipset 660 that can control input to and output from processor 655. In this example, chipset 660 outputs information to output 665, such as a display, and can read and write information to storage device 670, which can include magnetic media, and solid state media, for example. Chipset 660 can also read data from and write data to RAM 675. A bridge 680 for interfacing with a variety of user interface components 685 can be provided for interfacing with chipset 660. Such user interface components 685 can include a keyboard, a microphone, touch detection and processing circuitry, a pointing device, such as a mouse, and so on. In general, inputs to system 650 can come from any of a variety of sources, machine generated and/or human generated.

Chipset 660 can also interface with one or more communication interfaces 690 that can have different physical interfaces. Such communication interfaces can include interfaces for wired and wireless local area networks, for broadband wireless networks, as well as personal area networks. Some applications of the methods for generating, displaying, and using the GUI disclosed herein can include receiving ordered datasets over the physical interface or be generated by the machine itself by processor 655 analyzing data stored in storage 670 or 675. Further, the machine can receive inputs from a user via user interface components 685 and execute appropriate functions, such as browsing functions by interpreting these inputs using processor 655.

It can be appreciated that exemplary systems 600 and 650 can have more than one processor 610 or be part of a group or cluster of computing devices networked together to provide greater processing capability.

For clarity of explanation, in some instances the present technology may be presented as including individual functional blocks including functional blocks comprising devices, device components, steps or routines in a method embodied in software, or combinations of hardware and software.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware and/or software, and can take any of a variety of form factors. Typical examples of such form factors include laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

The various embodiments described above are provided by way of illustration only and should not be construed to limit the scope of the disclosure. Those skilled in the art will readily recognize various modifications and changes that may be made to the principles described herein without following the example embodiments and applications illustrated and described herein, and without departing from the spirit and scope of the disclosure.

We claim:

1. A product comprising:
a computer readable medium;
a widget module(s) comprised of computer readable code stored on the computer readable medium, the widget module configured to be executed by a web browser application when rendering a webpage and, when executed, configured to send multiple requests to a server; and
a batching module comprised of computer readable code stored on the computer readable medium, the batching module configured to be executed by a web browser application when rendering a webpage and, when executed, is further configured to:
collect more than one request from the widget module(s);
batch the more than one request; and
transmit the batched request to the server.

2. The product of claim 1, wherein the batching module is further configured to batch requests from the widget module(s) according to an organizational schema using multiple time periods.

3. The product of claim 1, wherein the batching module is further configured to:
collect requests received from the widget module(s) during a first time period into a first batch;
collect requests received from the widget module(s) during a second time period into a second batch; and
transmit the first batch and the second batch of requests to the server in separate communications.

4. The product of claim 1, wherein the batching module is further configured to:
receive a reply to the batched request from the server;
parse the reply into individual responses; and
send the individual responses to the widget module(s).

5. The product of claim 1, wherein the batching module is further configured to:
determine that a response to one or more of the more than one request from the widget module(s) that has been transmitted to the server is not received from the server before a predetermined threshold period closes.

6. The product of claim 5, wherein the batching module is further configured to:
send the server an interrupt signal configured to instruct that the server deliver a partial reply to the batched request.

7. The product of claim 6, wherein the interrupt signal is further configured to instruct the server to monitor for the response to one or more of the more than one request from the widget module that has been transmitted to the server, but that had not been received from the server before the predetermined threshold period closed.

8. The product of claim 1, wherein the batching module is further configured to determine that a request from the multiple requests is configured be sent to the server upon being received and to circumvent the process of being batched.

9. A webpage comprising an arrangement of code comprising:
one or more widget modules defined in code that arranges the webpage, the one or more widget modules configured to send multiple requests to a server; and
a batching module defined in code that arranges the webpage, the batching module configured to:
collect more than one request from the one or more widget modules;
batch the more than one request; and
transmit the batched request to the server.

10. The webpage of claim 9, wherein the batching module is further configured to:
receive one or more responses to the more than one request.

11. The webpage of claim 10, wherein the batching module is further configured to:
decipher the one or more responses;
identify a widget module from among the one or more widget modules which made the request associated with the response;
deliver the response to the identify widget module.

12. The webpage of claim 9, the arrangement of code further comprising:
a timing module defined in code that arranges the webpage, the timing module configured to start a time upon the one or more widget modules sending multiple requests to the server.

13. The webpage of claim 12, wherein the batching module is further configured to:
collect a first group of multiple requests over a first time frame;
batch the first group of multiple requests; and
transmit the first group of multiple requests to the server.

14. The webpage of claim 13, wherein the batching module is further configured to:
collect an additional group of multiple requests over an additional time frame after the first time frame;
batch the additional group of multiple requests; and
transmit the additional group of multiple requests to the server.

15. The webpage of claim 9, wherein the batching module is further configured to:
determine that a response to one or more of the more than one request from the widget module that has been transmitted to the server is not received from the server before a predetermined threshold period closes.

16. The webpage of claim 15, wherein the batching module is further configured to:
send the server an interrupt signal configured to request that the server deliver a partial reply to the batched request from the server.

17. The webpage of claim 16, wherein the interrupt signal is further configured to request that the server monitor for the response to one or more of the more than one request from the widget module that has been transmitted to the server, but that had not been received from the server before the predetermined threshold period closed.

18. The webpage of claim 9, wherein the batching module is further configured to determine that a request from the multiple requests is configured be sent to the server upon being received and to circumvent the process of being batched.
